(19) United States
(12) Patent Application Publication
(10) Pub. No.: US 2011/0058042 A1
(43) Pub. Date: Mar. 10, 2011

(54) Monitor Device, Switching Device, TV System, and Display Method

(76) Inventor: Tomotaka Ida, Kumagaya-shi (JP)

(21) Appl. No.: 12/795,534

(22) Filed: Jun. 7, 2010

(30) Foreign Application Priority Data
Sep. 9, 2009 (JP) 2009-207805

(51) Int. Cl. H04N 5/268; H04N 7/18

(52) U.S. Cl. 348/159; 348/705; 348/E05.057; 348/E07.085

(57) ABSTRACT

According to an aspect of the present invention, there is provided a monitor device including: a first port configured to receive videos output from an external switching device, the external switching device being connected to first input sources; a second port configured to receive a video output from an external source device as a second input source; and a display module configured to display: information about the first input sources, as a group, obtained through the external switching device; and information about the second input source, as a port name of the second port and/or apparatus information about the external source device, obtained from the external source device, wherein a switching operation between the first input sources and the second input source is performed in accordance with a switching instruction sent from an external manipulation device having a button to perform the switching operation.

### CROSS-REFERENCE TO RELATED APPLICATIONS

This application is based upon and claims the benefit of priority from Japanese Patent Application No. 2009-207805, filed on Sep. 9, 2009, the entire contents of which are incorporated herein by reference.

### BACKGROUND

1. Field

An aspect of the present invention relates to a TV system and, more particularly, to an external input switching method.

2. Description of the Related Art

Generally, the liquid crystal monitors require small occupation space and low power consumption. In recent years, with the reduction in their prices, liquid crystal monitors have spread rapidly as monitors of desktop personal computers. Liquid crystal monitors gained a position as a display device to succeed CRT displays so as to be close to ordinary consumers. Not only have liquid crystal monitors come to be used as PC monitors but also their use as TV receivers has increased widely by virtue of their style. For example, TV receivers have been proposed to which a game machine can be connected as an external input source (JP-2008-166898-A).

For example, in a TV receiver, a tuner unit and a monitor unit may be separated from each other. Further, as the monitor unit, a flat display device such as a liquid crystal display or an EL display may be used.

However, in such case, an external input source cannot be used with sufficient convenience.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates a system according to a first embodiment.

FIG. 2 illustrates an example configuration of the system according to the first embodiment.

FIG. 3 illustrates a remote controller used in the first embodiment which has a button that is dedicated to switching between monitor-side input sources.

FIG. 4 illustrates an example pin arrangement of an HDMI terminal used in the system according to the first embodiment.

FIGS. 5A and 5B are example drawings for explaining an IIC interface.

FIG. 6 illustrates an example list of switchable input subjects in the first embodiment.

FIGS. 7A and 7B partially illustrate a system according to the second embodiment.

### DETAILED DESCRIPTION

Various embodiments according to the present invention will be described hereinafter with reference to the accompanying drawings. In general, according to one embodiment of the present invention, there is provided a monitor device including: a first port configured to receive videos output from an external switching device, the external switching device being connected to first input sources; a second port configured to receive a video output from an external source device as a second input source; and a display module configured to display: information about the first input sources, as a group, obtained through the external switching device; and information about the second input source, as a port name of the second port and/or apparatus information about the external source device, obtained from the external source device, wherein a switching operation between the first input sources and the second input source is performed in accordance with a switching instruction sent from an external manipulation device having a button to perform the switching operation.

Embodiments of the present invention will be hereinafter described.

### Embodiment 1

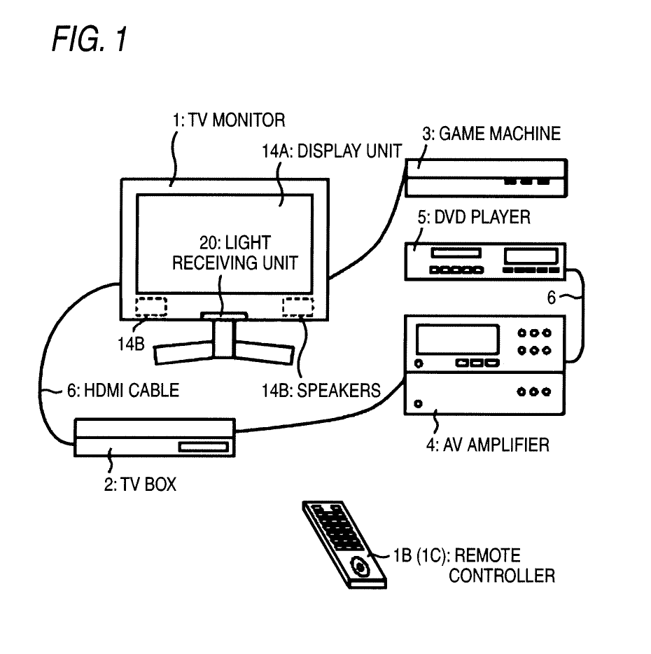

A first embodiment will be described below with reference to FIGS. 1-6.

FIG. 1 illustrates a TV system in which a TV monitor as a screen display unit and a TV box 2 as a broadcast receiving unit are separated from each other. The TV monitor 1 and the TV box 2 are connected to each other by a cable or a wireless communication. Each of the TV monitor 1 and the TV box 2 has plural external input terminals to each of which an external device is connected. In the system of FIG. 1, the TV monitor 1 and the TV box 2 are connected to each other by an HDMI (high-definition multimedia interface) cable 6.

The system includes the TV monitor 1 and the TV box 2 which are electronic apparatus for receiving, demodulating, and displaying a terrestrial digital broadcast or a satellite broadcast such as a BS (broadcast satellite) or CS (communication satellite) broadcast via an antenna or receiving and displaying video signal supplied from an external input source, and a DVD player 5 for reproducing a medium such as a DVD via an AV amplifier 4. A remote controller 1B (1C) is a dedicated remote controller for manipulating the TV monitor 1 and the TV box 2. The remote controller 18 (1C) can manipulate another electronic apparatus by sending an instruction signal to it via an HDMI cable 6. Whereas the remote controller 1B employing infrared light is widely used for the TV monitor 1, the remote controller 1C (RF remote controller) employing radio waves can be used for the TV monitor 1 or the TV box 2.

The TV monitor 1 checks connection, via an HDMI cable 6, to each electronic apparatus when the TV monitor 1 is powered on and also checks connection to each electronic apparatus at regular intervals during an operation. Information for a connection check is exchanged using a CEC control line of the HDMI cable 6.

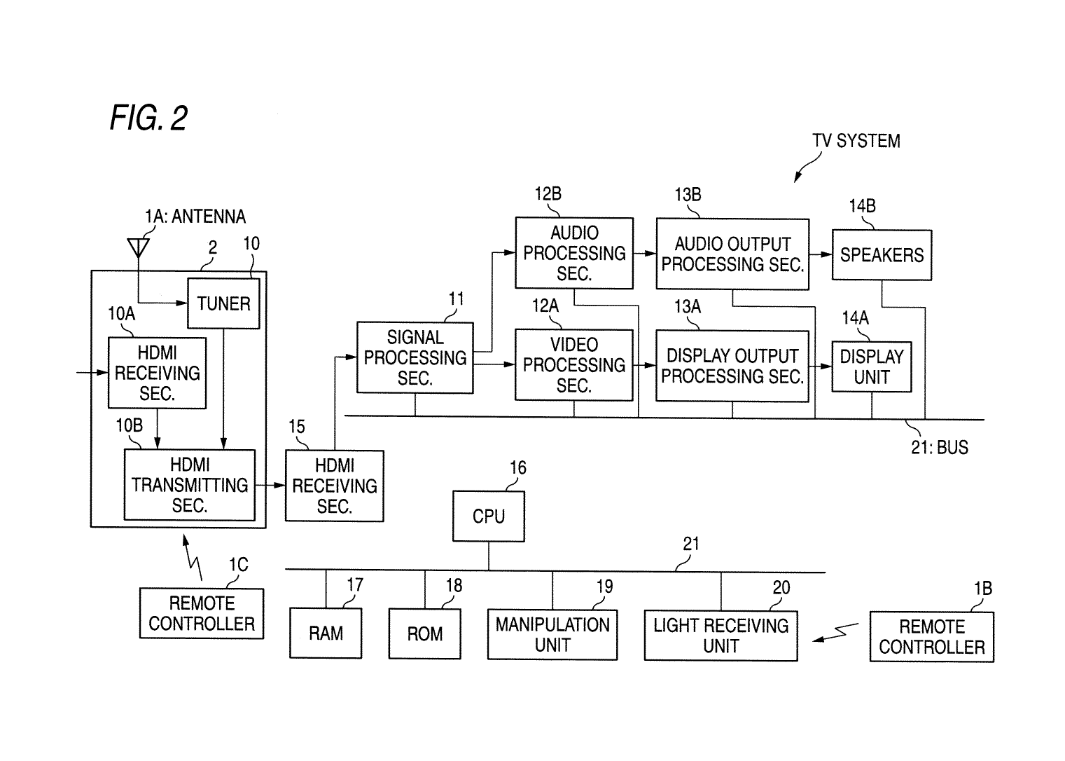

FIG. 2 illustrates an example configuration of the TV system according to the first embodiment. The TV system includes the TV monitor 1 and the TV box 2 which includes a tuner 10, an HDMI receiving section 10A, and an HDMI transmitting section 10B.

The TV monitor 1 includes a signal processing section 11, a video processing section 12A, a display processing section 13A, a display unit 14A, an audio processing section 12B, an audio output processing section 13B, speakers 14B, an HDMI receiving section 15, a CPU 16, a RAM 17, a ROM 18, a manipulation unit 19, and a light receiving unit 20. The TV box 2 also includes a simplified signal processing section (which performs video scaling etc.), a processor, memories, etc. and a receiving unit for the RF remote controller 10 (none of which are shown).

The tuner 10 receives, for example, a terrestrial digital TV broadcast waves (broadcast signal) via an antenna 1A, demodulates it, and outputs a resulting program signal via the HDMI transmitting section 10B. The signal processing section 11 receives the output of the tuner 10 via the HDMI receiving section 15, separates it into various types of data such as video data, audio data, and caption data, and processes those data. The video processing section 12A decodes the video data and the caption data that are output from the signal processing section 11. The display processing section 13A converts the output of the video processing section 12A into a display video signal and outputs the latter. The display unit 14A displays the output of the display processing section 13A on a display portion such as an LCD (liquid crystal display).

The audio processing section 12B decodes the audio data that is output from the signal processing section 11. The audio output processing section 13B converts the output of the audio processing section 12B into audio signals and outputs the latter. The speakers 14B convert the outputs of the audio output processing section 13B into a sound.

The CPU 16 controls the individual sections and units of the TV monitor 1. The RAM 17 temporarily stores data to be processed by the CPU 16. The ROM 18 stores programs such as firmware and related data in a nonvolatile manner. The manipulation unit 19, which includes plural switches etc., manipulates the TV monitor 1 according to an input made through a switch. The light receiving unit 20 receives an instruction that is transmitted from the remote controller 1B in the form of an infrared signal. The individual sections and units are connected to each other by a bus 21.

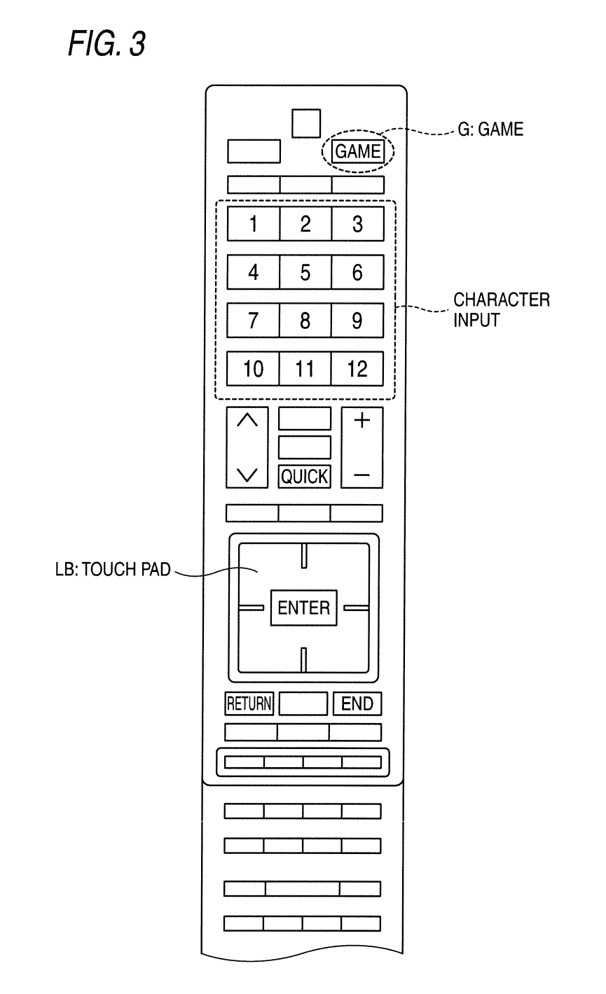

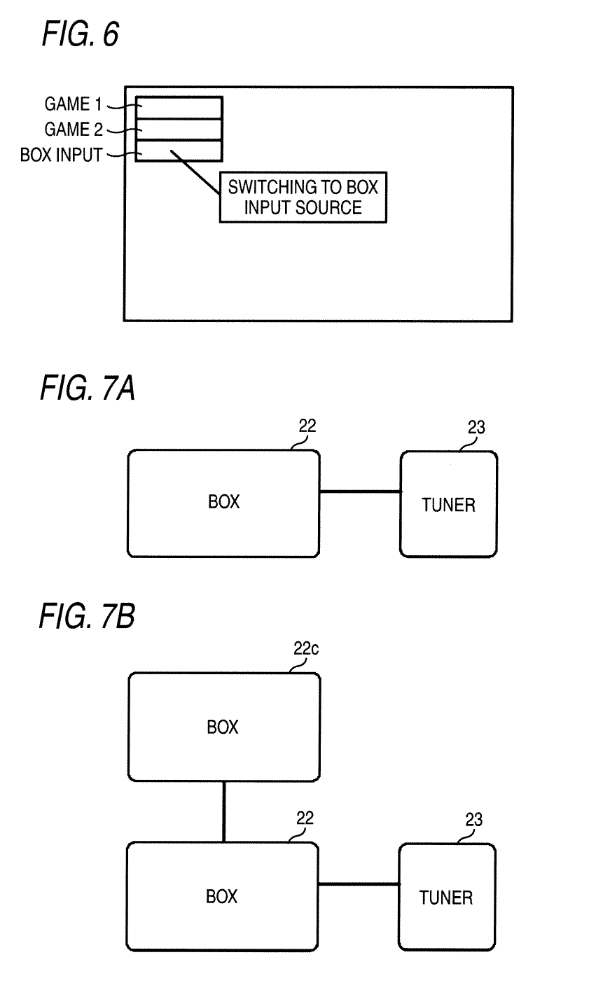

FIG. 3 illustrates the remote controller 1B for manipulating the system. The remote controller 1B is provided with a button that is dedicated to switching between monitor-side input sources. The remote controller 10 may be provided with the same buttons etc. as the remote controller 1B. The remote controller 1B (1C) is provided with the dedicated button for a manipulation. The dedicated button is a game button G which is enclosed by a broken line in FIG. 3. The function of the game button G will be described later with reference to FIG. 6. Other buttons whose functions are deeply related to the embodiment will be listed below.

A return button is manipulated to return to a preceding menu picture halfway in a process of making any of various settings etc.

An end button is, in general, manipulated to finish a setting procedure and erase a menu.

A quick button is manipulated at each stage to display a quick menu corresponding to the stage.

Character input buttons are manipulated to select a channel directly and are also manipulated in making a setting that requires input of characters, numerals, and/or symbols.

An enter button is manipulated to decide on an item selected through a menu at each stage in making any of various settings etc.

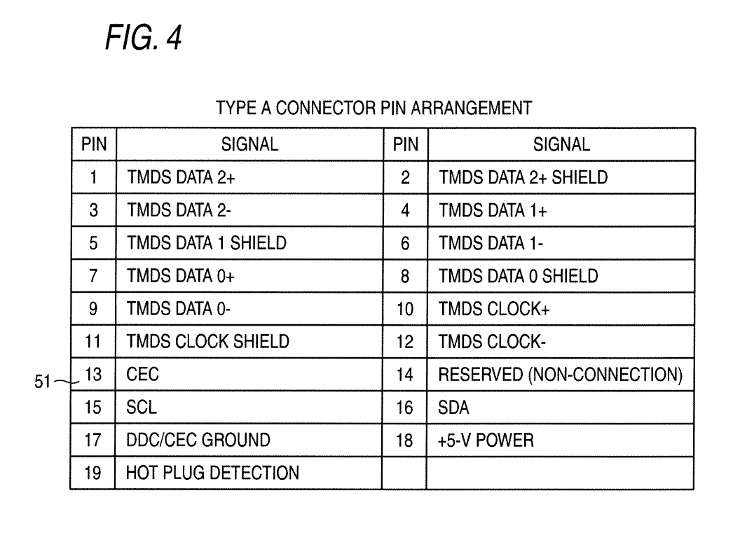

Next, a terminal pin arrangement will be described taking, as an example, the terminal of each of the HDMI receiving sections 10A and 15. This HDMI terminal has a connector pin arrangement as shown in FIG. 4. In this pin arrangement, a CEO (consumer electronics control) pin 51 (pin 13), an SCL (serial data clock line) pin (pin 15), an SDA (serial data analyzer) pin (pin 16), and a +5-V power pin (pin 18) are suitably used for detecting a connection state of an HDMI apparatus.

HDMI clocks include not only a TMDS clock for video but also an SCL clock (serial clock) of a DDC (display data channel) line. The IIC interface includes an SCL line and an SDA (serial data) line which is a data line, and DDC lines receive an instruction via a serial bus compatible with the IIC interface.

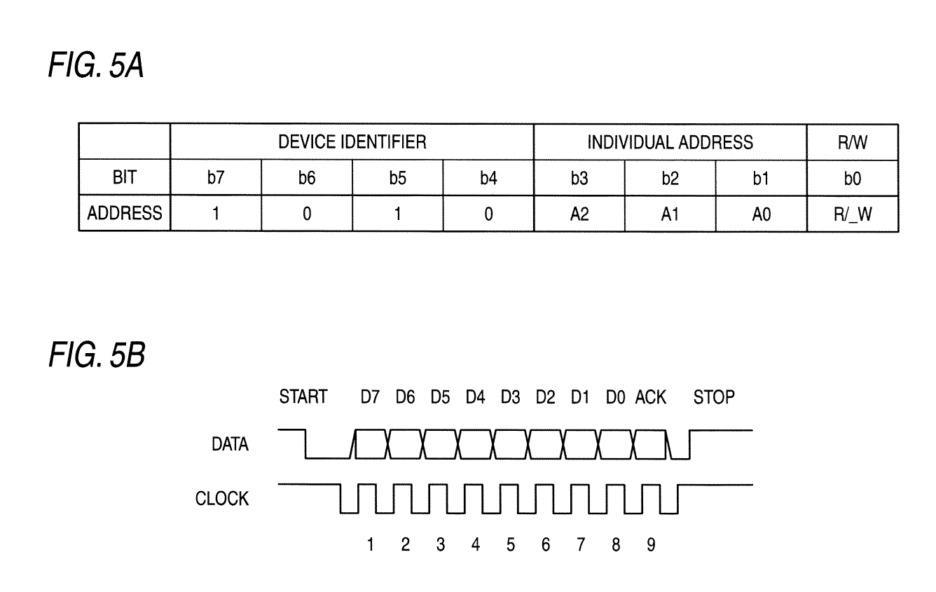

FIGS. 5A and 5B are example drawings for explaining the IIC interface. The IIC interface bus consists of two communication lines, that is, a line for a pulled-up clock output from a master device and a line for data in a bidirectional communication between the master device and a slave device.

FIG. 5A illustrates an example slave address. The slave address has an 8-bit length and the upper 4 bits are fixed depending on a device type. The LSB indicates writing and reading when it is “0” and “1,” respectively. Therefore, actually, only bit 1 to bit 3 of the slave address can be used.

FIG. 5B illustrates an example timing relationship between the two lines. As shown in the top part of FIG. 5B, transmission of data is started when the data line goes low and data is transmitted in order starting from the MSB. A stop state is established when the data line goes high. The timing of the corresponding clock line is shown in the bottom part of FIG. 5B. FIG. 5B corresponds to a case of transmitting 1-byte data. By transmitting a set of data and ACK plural times repeatedly until a stop state is established, a slave address (first byte) and a communication content (ensuing bytes) can be transmitted.

Next, methods for detecting a connection state of an HDMI apparatus will be described. First, a potential of the DDC line which consists of the SCL pin (pin 15) and the SDA pin (pin 16) is detected in a state that an electronic apparatus such as an HDD recorder, an AV amplifier, or the like is connected to the HDMI input terminal by an HDMI cable.

Next, 5-V power detection is performed to detect +5-V power of pin 18 in a state that an HDMI cable is connected to the HDMI terminal. CEC detection is performed to detect a communication state (i.e., whether a communication is being made with a partner apparatus) of the CEC pin (pin 13) in a state that an HDMI cable is connected to the HDMI terminal.

For example, whether an apparatus connected to the HDMI terminal by an HDMI cable is in operation can be detected through 5-V power detection.

FIG. 6 illustrates an example picture on the monitor screen in which a list of switchable input subjects is displayed upon a manipulation of the game button G of the remote controller 1B. In the displayed input subjects (switching items) include not only monitor-side input items but also box-side input item.

“Game1” and “Game2” in FIG. 6 correspond to monitor-side external input terminals. For example, “Camel” corresponds to a 6th (among monitor-side ones and tuner-side ones) general-purpose HDMI input terminal (HDMI6) and “Game2” corresponds to a 4th (among monitor-side ones and tuner-side ones) video input terminal (Video4). Port names “HDMI6” and “Video4” are displayed for “Game1” and “Game2,” respectively. Information (e.g., apparatus names) about apparatus connected to the input terminals of “Game1” and “Game2” may be displayed for the user's convenience, when it is acquired.

“Box Input” in FIG. 6 corresponds to an input from the box 2. The input line to the box 2 shown in FIG. 1 is the dedicated HDMI input line. For example, the box 2 is provided with five general-purpose HDMI input terminals (HDMI1-HDMI5) and three video input terminals (Video1-Video3).

As a detailed information of “Box Input”, an input source of the box 2 may be presented. For example, in the system of FIG. 1, the input source of the box 2 is the AV amplifier 4. Another example input source is a channel received through a tuner. If “Box Input” is switched to an input terminal to which no input source is connected, the fact that it is an ineffective input terminal may be indicated by graying-out, for example. If no apparatus is connected to an HDMI input terminal, a judgment may be made by checking the above-described DDC line.

Every time the game button G is pressed, switching is made between “Game1,” “Game2,” and “Box Input” cyclically and a corresponding input source is displayed on the monitor screen. For example, a display as shown in FIG. 6 is presented for a given time (for example, one second) after pressing of the game button G.

The selected item may be switched in order of “Game1,” “Game2,” and “Box Input” or in the opposite order every time a line portion LB of a touch pad is pressed, after pressing of the game button G.

### Embodiment 2

A second embodiment will be described below with reference to FIG. 1 to FIGS. 7A and 7B. Sections, units, etc. having the same ones in the first embodiment will not be described in detail.

FIGS. 7A and 7B partially illustrate a system according to the second embodiment. The TV box 2 shown in FIG. 1 is divided into a box 22 and a tuner 23. Although not shown, the antenna 1A is connected to the tuner 23. The box 22 and the tuner 23 are connected to each other via an HDMI cable. The box 22 is provided with a switching module (not shown) which receives an instruction to switch input source transmitted from the TV monitor 1, and switches between input sources according to the received instruction.

In the example of FIG. 7A, the box 22 and the tuner 23 correspond to the TV box 2. In the example of FIG. 7B, a box 22c is provided upstream of the TV monitor 1 (the box 22c is provided between the TV monitor 1 and the box 22 and the boxes 22 and 22c are connected to each other in cascade). The boxes 22 and 22c are connected to each other by a cable such as an HDMI cable. The boxes 22 and 22c have the same function.

Whereas the system of FIG. 7A operates in the same manner as the system according to the first embodiment, the system of FIG. 7B can operate differently as described below. That is, as in the first embodiment, the switchable input sources of the box 22c are presented as the detailed information of “Box Input”. In the example of FIG. 7B, the box 22 is presented as the switchable input source of the box 22c. When the function also has cascading capability, the tuner 23, an input source (e.g., external input source) of the box 22 can be presented as he detailed information of “Box Input”.

Degree (e.g., number of stages) of cascade capability to be provided can easily be set by the content of the CEO control. In the system of FIG. 7A, an equivalent box may be provided downstream of and connected to the box 22.

The second embodiment is more extendable to multiple input sources than the first embodiment because general-purpose boxes can be connected to each other in cascade.

General remote controller may have a common input switching button for switching between the tuner of a TV receiver and external input sources or have input switching buttons in the number of input terminals. However, there is no remote controller (for a separate-type TV receiver) which is provided with a button for switching between monitor-side input sources and box-side input sources which are grouped.

Each of the above embodiments provides a TV system which allows the user to select, clearly and quickly, an external device that is connected to a monitor-side external input terminal and which also can return to a broadcast channel or an external input source of last viewing in returning to a monitor-side input source.

In summary, the embodiments provide the following:

(1) A TV system composed of a monitor as a screen display unit and a box as a broadcast receiving unit which are provided separately from each other, the TV system being provided with a dedicated remote control button which can cause presentation of plural monitor-side external input sources together and enables switching between them.

(2) An input switching system which can display a list including not only plural monitor-side external input sources but also box-side input sources upon pressing of the dedicated remote control button and makes it possible to switch between them sequentially.

(3) A multi-control TV system in which a box-side broadcast channel or external input source that was selected last by the user is stored and switching can be made to it and resulting display can be performed when a box input source is selected.

The invention is not limited to the above embodiments and can be practiced so as to be modified in various manners without departing from the spirit and scope of the invention.

And various inventions can be conceived by properly combining plural constituent elements disclosed in each embodiment. For example, several ones of the constituent elements of each embodiment may be omitted. Furthermore, constituent elements of different embodiments may be combined as appropriate.

An aspect of the present invention provides a TV system capable of providing enhanced convenience in using an external input source.

What is claimed is:

1. A monitor device comprising:
a first port configured to receive videos output from an external switching device, the external switching device being connected to first input sources;
a second port configured to receive a video output from an external source device as a second input source; and
a display module configured to display:
information about the first input sources, as a group, obtained through the external switching device; and
information about the second input source, as a port name of the second port and/or apparatus information about the external source device, obtained from the external source device,
wherein a switching operation between the first input sources and the second input source is performed in accordance with a switching instruction sent from an external manipulation device having a button to perform the switching operation.

2. A switching device comprising:
an extension port configured to receive videos output from first input sources;
a switching module configured to switch between the first input sources in accordance with a switching instruction sent from an external manipulation device; and
an output module configured to output a video of a switched one of the first input sources selected by the switching module to an external monitor device.

3. A TV system comprising:
a switching device comprising:
an extension port configured to receive videos output from first input sources;
a switching module configured to switch between the first input sources; and
an output module configured to output a video of a switched one of the first input sources;
a monitor device comprising:
a first port configured to receive the videos output from the switching device as the first input sources;
a second port configured to receive a video output from an external source device as a second input source; and
a display module configured to display:
information about the first input sources, as a group, obtained through the switching device; and
information about the second input source, as a port name of the second port and/or apparatus information about the external source device, obtained from the external source device; and
a manipulation device configured to send a switching instruction so as to equally perform a switching operation between the first input sources and the second input source.

4. The TV system of claim 3, further comprising:
a tuner device configured to output a tuned broadcast signal,
wherein the tuned broadcast signal is included in the first input sources.

5. The TV system of claim 3,
wherein, when the switching operation for the first input sources is performed, the monitor device displays the previously-selected one of the first input sources.
